(19) United States
(12) Patent Application Publication
(10) Pub. No.: US 2025/0307818 A1
(43) Pub. Date: Oct. 2, 2025

(54) PASSIVE SECONDARY AUTHENTICATION

(71) Applicant: American Express Travel Related Services Company, Inc., New York, NY (US)

(72) Inventors: Alaric M. Eby, Scottsdale, AZ (US); Andras L. Ferenczi, Scottsdale, AZ (US); Juan B. Figuera, New York, NY (US)

(21) Appl. No.: 18/616,413

(22) Filed: Mar. 26, 2024

(51) Int. Cl. G06Q 20/40; G06Q 20/20; G06Q 20/32

(52) U.S. Cl. CPC G06Q 20/40145; G06Q 20/20; G06Q 20/326; G06Q 20/3278

(57) ABSTRACT

Examples herein can receive a request to authorize a card payment from a point-of-sale device. The request is associated with an attempted card payment. The system further determines a user account associated with the payment request and identifies at least one passive authentication factor linked to the user account. The passive authentication factor is associated with at least one device associated with the user account. The system then determines whether the passive authentication factor is satisfied by analyzing the device. If the passive authentication factor is satisfied, the system transmits a transaction authorization indication to the point-of-sale device.

### BACKGROUND

When a user initiates a mobile payment using a mobile device, the user often presents the mobile device to a point-of-sale device. A user has typically setup a mobile wallet on the mobile device by linking a payment instrument to the mobile wallet, which often requires interaction or approval by an issuer of the payment instrument. The user then authenticates his or her identity with a software interface on the mobile device or within a mobile wallet application, often by presenting the mobile device to the point-of-sale device.

The point-of-sale device and mobile device often communicate via near field communication (NFC). The mobile device, in some cases, can include a secure element, which is a chip that can store a token corresponding to a payment instrument. The secure element can also store executable code that can facilitate communication with the point-of-sale device on behalf of the mobile wallet application running on the mobile device.

The mobile wallet application can require a biometric authentication or a passcode of a user to initiate and/or complete a mobile payment. Beyond authenticating with the mobile wallet application or with a device operating system of the mobile device, there are typically no additional authentication measures that are required to make a mobile payment. Introducing additional authentication measures, such as a secondary authentication code, can create a cumbersome user experience.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart according to various examples of the disclosure illustrating functionality of a client application in the network environment of FIG. 1.

FIG. 3 is a flowchart according to various examples of the disclosure illustrating functionality of a payment authorization service in the network environment of FIG. 1.

FIG. 4 is a flowchart according to various examples of the disclosure illustrating functionality of a secondary device in the network environment of FIG. 1.

FIG. 5 is a flowchart according to various examples of the disclosure illustrating functionality of a client application in the network environment of FIG. 1.

### DETAILED DESCRIPTION

Disclosed are various approaches for performing passive secondary authentication for credit card payment transactions. In general, a credit card payment transaction involves presenting a payment instrument such as a credit card or a mobile device running a mobile wallet application to a point-of-sale (POS) device. The POS device can provide the information associated with the payment information along with transaction details, such as an amount, currency, type of goods, an identifier associated with the merchant, location information, or other data that might be included in a request to authorize a card payment. The payment instrument information and transaction information can be provided to a system or computing device associated with an acquiring bank associated with the merchant.

The acquiring bank can forward the payment instrument information and transaction information to a card network associated with the payment instrument. The payment network can route the provided data to the issuing bank of the payment instrument. The issuing bank can determine whether the payment instrument has sufficient funds availability, whether the payment instrument has exceeded spending limits imposed by the bank or by the user, and also perform fraud detection measures that can be ascertained based upon an analysis of the transaction information and the payment instrument information.

Upon performing the above checks, the issuing bank can either provide an authorization message to the payment network, which can route the authorization to the merchant's acquiring bank, which can in turn route the authorization message to the POS device. If the payment request is denied by the issuing bank, the issuing bank's systems can provide a rejection message that is similarly routed to the POS device.

Examples of this disclosure can involve perform additional passive authentication measures on behalf of the issuing bank before approving or denying a card payment request that is routed from a POS device on behalf of a user account. For example, when a user presents a payment card (e.g., a credit card, debit card, or charge card) or a mobile device running a mobile payment application to a POS device, examples of the disclosure can identify additional devices associated with an account of the user. Examples of such additional devices include the mobile application presenting the card or a different mobile device of the user, a wearable device, a tracking device that can track the location of an object to which the tracking device is attached, or other devices that can be linked to the user's account. Upon identifying devices associated with the account of the user, examples of the disclosure can perform additional authentication checks against these other devices. For example, the presence of an additional device in a known location associated with the POS device can be verified. As another example, biometric data can be obtained from a wearable device of the user, such as a heart rate, blood pressure, or other biometric data. The biometric data can be verified as within a certain range based upon historical biometric data of the user or a range that is designated to be a normal range.

The issuing bank can determine whether the additional authentication checks reveal anomalous behavior in addition to performing traditional fraud detection measures before approving or denying a request to approve the card payment. Traditional fraud detection measures often fail to take into account real-time data that can be obtained from other devices of the user, even though the user might own or carry multiple devices from which real-time data can be obtained and analyzed. To improve the accuracy of these fraud detection measures, the present disclosure provides approaches obtaining real-time information from more than one user device, which can be analyzed for fraud detection or identity verification purposes, which can improve upon traditional verification approaches.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

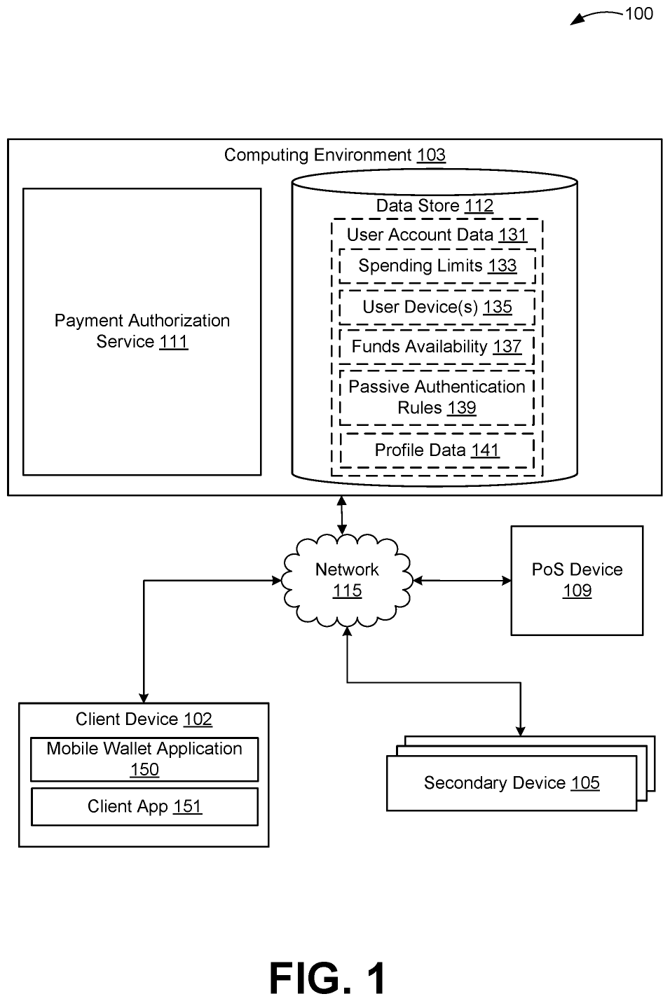

With reference to FIG. 1, shown is a network environment 100 according to various embodiments. The network environment 100 can include a computing environment 103 and one or more client devices 102, and one or more secondary devices 105 which can be in data communication with each other via a network 115.

The network 115 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 115 can also include a combination of two or more networks 115. Examples of networks 115 can include the Internet, intranets, extranets, virtual private networks (VPNs), and similar networks.

In various examples, the network 115 can include a payment network for facilitating a processing of a payment. The payment network can include an open network or a closed loop network. The open network may be a network that is accessible by various third parties and/or a network in which banking systems from different entities interact. Alternatively, the network 115 can also be a closed loop network. For example, the closed loop network can include issuer bank systems and acquiring bank systems, in which third parties can be restricted from accessing the closed loop network. For instance, a single financial entity can have the issuing banking systems and the acquiring banking systems in a single payment network. In this scenario, the single financial entity has payment data related to the payment accounts for individual users and the payment processing data related to merchant accounts and/or owed balance operators.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include the payment authorization service 111, and other applications, services, processes, systems, engines, or functionality not discussed in detail herein. The payment authorization service 111 can be executed to determine whether a card payment request should be approved or denied. The payment authorization service 111 can make such a determination by analyzing the transaction details associated with the card payment request as well as by performing passive secondary authentication according to examples of the disclosure. Passive secondary authentication is performed without requiring an additional user interaction at the time of authentication. Therefore, a user would not have to provide a one-time password, interact with another device or person, or take any explicit or affirmative actions to authorize the transaction. The payment authorization service 111 can identify one or more passive secondary authentication factors associated with a user account and perform passive secondary authentication before approving or denying a respective card payment request.

Also, various data is stored in a data store 112 that is accessible to the computing environment 103. The data store 112 can be representative of a plurality of data stores 112, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 112 is associated with the operation of the various applications or functional entities described below. This data can include user account data 131 and potentially other data.

The user account data 131 can correspond to a financial account associated with a user and provided and managed by the entity associated with the first computing environment 103. The user account data 131 can include an account holder name, an account holder address, an account number, a card number, an account balance, an account transaction ledger, and/or other data. The user account data 131 can further include information from which the payment authorization service 111 can make a determination to approve or deny a card payment request received from a POS device 109 on behalf of a user.

For example, the user account data 131 can comprise spending limits 133, funds availability 137, and profile data 141. The spending limits 133 can specify how much spending is permitted in a given time period that a particular user account or a card associated with a user account. Funds availability 137 can specify how much funds are associated with a user account, which can also help define how much spending is permitted for a given user account or a card associated with a user account. Profile data 141 can comprise a user's name, address, location, travel profile, spending habit data, spending history data and other profile information that can be stored about a user.

User account data 131 can include user device data 135. User device data 135 can identify one or more devices that are associated with a user account. A user device can represent a mobile device, such as a user's phone, a wearable device, such as a smart watch, a tracking device, such as a location tracker, or any other computing device that a user can associated with his or her user account.

By associating additional devices with a user account, a user can allow for secondary authentication factors to be utilized by the payment authorization service 111 to further secure card transactions made with the user's card.

Passive authentication rules 227 can represent rules that are setup by the user or automatically created by the payment authorization service 111 on behalf of a user account. A passive authentication rule 139 represents secondary authentication measure that can be utilized to determine whether to approve or deny a card payment request received from a point-of-sale device 109 on behalf of a payment instrument, such as a credit card, that is presented to the point-of-sale device 109 to pay for a transaction. A passive authentication rule 139 can require presence of one or more secondary devices 105, such as a phone, wearable, or tracker, in a location associated with the point-of-sale device 109 before approval of a card payment request is provided by the payment authorization service 111 to the point-of-sale device 109.

A passive authentication rule 139 can require that a user explicitly approve or deny a payment using one or more secondary devices 105 before approval of a card payment request is provided by the payment authorization service 111 to the point-of-sale device 109. A passive authentication rule 139 can require a biometric factor be captured by one or more secondary devices 105 and be provided to the payment authorization service 111 before approval of a card payment request is provided by the payment authorization service 111 to the point-of-sale device 109. As another example, a passive authentication rule 139 can require that a biometric factor, such as heart rate, blood pressure, or a stress-related biometric data point, be captured by a wearable device or another device of the user, report a biometric factor that is within an acceptable range before approval of a card payment request is provided by the payment authorization service 111 to the point-of-sale device 109.

The client device 102 is representative of a plurality of client devices that can be coupled to the network 115. The client device 102 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a videogame console, a wearable device, such as a smart watch, a tracking device that facilitate location tracking capabilities, or other devices with like capability. The client device 102 can include one or more displays 167, such as liquid crystal displays (LCDs), gas plasma-based flat panel displays, organic light emitting diode (OLED) displays, etc.

The client device 102 can be configured to execute various applications such as a client application 151, a mobile wallet application 150, or other applications. The client application 151 can be executed in a client device 102 to access network content served up by the first computing environment 103, the second computing environment 106, or other servers, thereby rendering a user interface on the display. To this end, the client application 151 can include a browser, a dedicated application, or other executable, and the user interface can include a network page, an application screen, or other user mechanism for obtaining user input.

The client application 151 can represent an application provided to users to facilitate management of user accounts, viewing and paying bills, managing authorized users on an account, viewing shopping offers, receiving account alerts, obtaining customer service, and performing other tasks related to a user account. The client application 151 can also include a payments app with which users can make peer-to-peer payments or payments to merchants. In examples of this disclosure, the client application 151 can also facilitate performing passive secondary authentication on behalf of the payment authorization service 111.

The client application 151 can allow the user to associate one or more secondary devices 105 with his or her user account. For example, the client application 151 can provide a user interface through which the user can pair a wearable device, a tracking device, or another computing device with his or her user account. Once paired with a user account, the payment authorization service 111 can utilize the one or more secondary devices 105 as passive secondary authentication factors. For example, the payment authorization service 111 can detect presence of one of the one or more secondary devices 105 in a location associated with a point-of-sale device 109 before approving a card transaction.

In some cases, the payment authorization service 111 can detect presence of a secondary device 105 through the client application 151 because a secondary device 105 may not have its own network capabilities. In this scenario, the payment authorization service 111 can transmit a request to the client application 151 to detect presence of one or more secondary devices 105 associated with a user account linked to a card transaction request. The client application 151 can attempt to locate a one or more secondary devices 105 via a network interface, a Bluetooth interface, a near field communication interface, or any other communication interface of a client device 102. If a secondary device 105 can be located, the client application 151 can report presence of the secondary device 105 to the payment authorization service 111.

The mobile wallet application 150 can allow the client device 102 to be utilized for mobile payment transactions. A user can add a payment instrument, such as a credit card, debit card, bank account, etc., to a mobile wallet application 150 on the client device 102 and present the client device 102 to a point-of-sale device 109 to conduct a payment transaction. The mobile wallet application 150 can tokenize the payment instrument credit card and store the tokenized data in a secure element on the client device 102.

The one or more secondary devices 105 represent other devices of a user that can be paired with a user account. A secondary device 105 can comprise another mobile device, computing device, wearable device (e.g., ring, watch, pendant, etc.), location tracking device, or any other device that can communicate with a client device 102 or with the computing environment 103. Certain secondary devices 105 may not possess the capability to communicate with the network 115 and can only communicate with the client device 102. For example, a secondary device 105 might only communicate with nearby devices, such as the client device 102, via ultra wide-band, Bluetooth, or near field communication. Such a device might be able to be detected by the client application 151 as in proximity to the client device 102.

The point-of-sale device 109 represents a computing device that can be utilized by a merchant to process payments for users, such as customers. A point-of-sale device 109 can comprise an interface that can obtain information from a credit card, such as a magnetic stripe reader, a smart payment card chip reader, such as an EMV chip reader, a contactless card reader interface, or any other card reader interface. The point-of-sale device 109 can also include a near field communication (NFC) or ultra-wideband interface to communicate with a client device 102 that is presented as a payment instrument by way of a mobile wallet application 150 running on the client device 102.

The point-of-sale device 109 can also include a network interface with which the point-of-sale device 109 can communicate via the network 115 with the payment authorization service 111 for the purpose of transmitting transaction details and card information to authorize card payment transactions on behalf of the merchant.

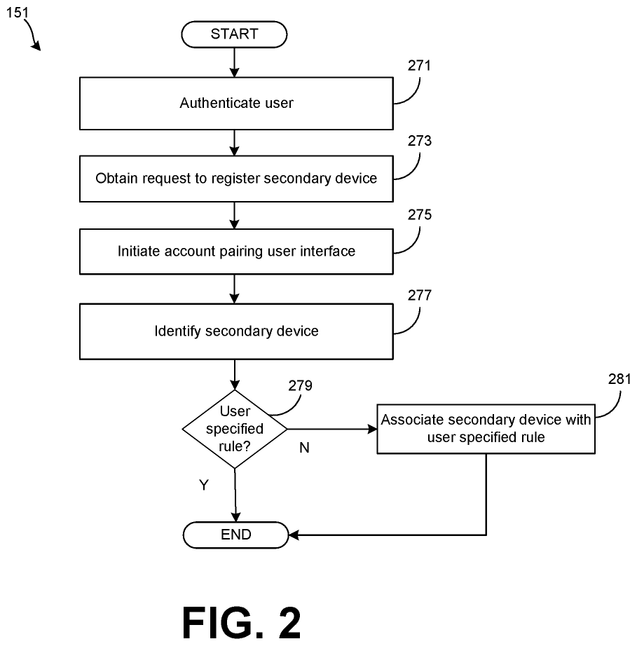

FIG. 2 illustrates a flowchart that provides an example of the operation of the components of the network environment 100. It is understood that the flowchart of FIG. 2 provides merely an example of the many different types of functional arrangements that can be employed to implement the operation of the depicted portion of the network environment 100. As an alternative, the flowchart of FIG. 2 can be viewed as depicting an example of elements of a method implemented within the network environment 100. In particular, the flowchart of FIG. 2 depicts the how the client application 151 can be utilized to establish secondary authentication factors for a user account.

Beginning with block 271, the client application 151 can authenticate a user. The user can be required to log into a user account and verify his or her identity. In some cases, an active secondary authentication factor, such as a TOTP code, an SMS code, a biometric authentication, or other identity verification processes can be utilized to verify the user's identity.

At block 273, the client application 151 can obtain a request to register a secondary device 105 and associate the secondary device 105 with a user account of the user. In one example, the user can select an option provided within the client application 151 to register a secondary device 105 that can be utilized for passive secondary authentication according to examples of the disclosure. In some examples, a card issuer might require the user to associate one or more secondary devices 105 with a user account for passive secondary authentication.

At block 275, the client application 151 can initiate a pairing user interface in which the user can select one or more secondary devices 105 to associated with the user account. The user interface can allow the user to select one or more secondary devices 105 from various connectivity interfaces of the client device 102. For example, the user can select a Bluetooth device that is paired with the client device 102 or one that has not yet been paired with the client device 102. The user can select a device that is accessible via an ultra-wideband communication interface or via the Internet. The user can select one or more secondary devices 105 within the user interface for pairing with the user account. The one or more secondary devices 105 can be stored in association with the user account data 131 by adding a reference to the device to user device data 135. For example, one or more device identifiers can be stored as user device data 135.

At block 277, the client application 151 can identify the secondary device 105 selected by the user at block 275. The client application 151 can generate or identify a device identifier that uniquely identifies the secondary device 105 with respect to other secondary devices. Additionally, the client application 151 can identify how the secondary device 105 can be contacted by the payment authorization service 111. In the case of a secondary device 105 that cannot independently communicate with the Internet, the client application 151 can communicate with the secondary device 105 on behalf of the payment authorization service 111.

At block 279, the client application 151 can allow the user to specify a passive secondary authentication rule 227 to be enforced with respect to the selected secondary device 105. In some examples, the client application 151 can provide a user interface in which the user can specify a rule for which passive secondary authentication is required for card transactions with one or more of the user's cards. For example, the user can specify that for transactions exceeding a particular transaction amount, that the payment authorization service 111 should perform passive secondary authentication using the selected secondary device 105 before approving the transaction. As another example, the user can specify that for transactions with a certain merchant or certain category of merchant, that passive secondary authentication should be performed by the payment authorization service 111 before approving the transaction.

The user-specified passive authentication rule 139 can also allow the user to specify a type of passive secondary authentication. In one example, the passive secondary authentication can require presence of the secondary device 105 in proximity to the point-of-sale device 109 with which a transaction is being attempted. Presence of the secondary device 105 can be detected in some cases by the client application 151. The payment authorization service 111 can transmit a request to the client application 151 running on a client device 102 to detect presence of the secondary device 105. The client application 151 can attempt to contact a secondary device 105 using a Bluetooth interface, ultra-wideband interface, or any other communication interface with which the secondary device 105 is linked to the client device 102. If the secondary device 105 can be contacted by the client application 151, the client application 151 can report presence of the secondary device 105 to the payment authorization service 111. If the secondary device 105 cannot be contacted by the client application 151, the client application 151 can report that the secondary device 105 is not present.

A user-specified rule can also specify other factors, such as biometric measurements, velocity, or location. For example, the user can specify that for some or all transactions, that a user's heart rate or blood pressure as detected by a secondary device 105 having biometric measuring capabilities should be within a normal or specified range. The user can also specify that the velocity of the user as detected by a secondary device 105 should be less than a maximum velocity. The user can also specify that some or all transactions require verification of the user's location, either by presence of a secondary device 105 in proximity to the point-of-sale device 109, or within a specified geofence selected by the user.

The user can also specify multiple rules or checks that should be performed by potentially multiple secondary devices 105 for the payment authorization service 111 to approve a transaction. For example, the user can specify that presence of multiple secondary devices 105 should be confirmed by the client application 151 before allowing the payment authorization service 111 to approve a transaction. The user can also specify that presence of secondary devices 105 and biometric data should be checked by the client application 151 or the payment authorization service 111 before approving a transaction.

A passive authentication rule 139 specified by a user can be saved by the client application 151 in association with the user account data 131 or a user profile of the user.

If the user does not specify a rule, then the process can proceed from block 279 to completion. If the user specifies a rule, the process can proceed from block 279 to 281, where the client application 151 can associate the user-specified rule with the user account data 131 of the user. The client application 151 can transmit the passive authentication rule 139 to the payment authorization service 111, which can store the passive authentication rule 139 in the data store 112 in association with the user account.

Thereafter, this portion of the process proceeds to completion.

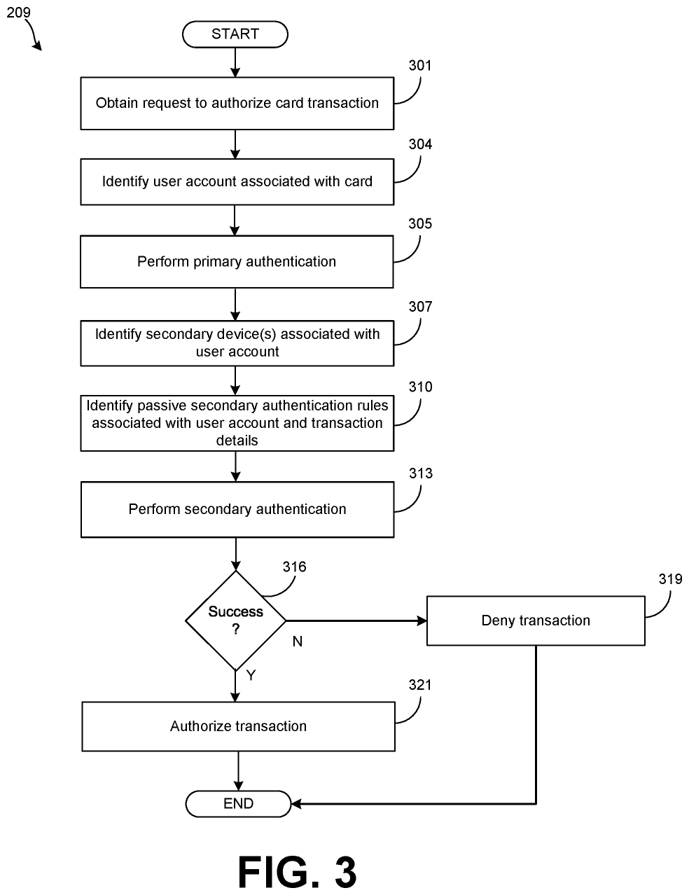

FIG. 3 illustrates a flowchart that provides an example of the operation of the components of the network environment 100. It is understood that the flowchart of FIG. 3 provides merely an example of the many different types of functional arrangements that can be employed to implement the operation of the depicted portion of the network environment 100. As an alternative, the flowchart of FIG. 3 can be viewed as depicting an example of elements of a method implemented within the network environment 100. In particular, the flowchart of FIG. 3 depicts the how the payment authorization service 111 can perform passive secondary authentication for approving a card transaction request by utilizing secondary devices 105 that are associated with a user account.

Beginning with block 301, the payment authorization service 111 can receive a request to authorize a card transaction. The request can be received from or on behalf of a point-of-sale device 109 to which a user has presented a payment or transaction card (e.g., a debit, credit, or charge card) or a client device 102 running a mobile wallet application 150 with which a payment account (e.g., a credit, debit, or charge card account; a bank account; etc.) of the user is linked. In some cases, the request to authorize a card transaction can be received from an online payment gateway if the user is attempting an online payment transaction.

As noted above, the payment journey can traverse other systems that can vary depending upon whether an open loop or a closed loop payment network is being utilized. For example, there can be systems associated with a merchant acquiring bank, a payment network, and a card issuing bank that are involved in forwarding the request to the payment authorization service 111. The request can comprise transaction details identifying various transaction details of the requested transaction, such as an amount of the transaction, an identity of the merchant, the type of goods or services involved in the transaction, a location of the merchant, and other transaction details that the point-of-sale device 109 can collect and provide to the payment authorization service 111 depending upon the requirements of the payment authorization service 111. The request can also include details of the card that was presented to the point-of-sale device 109, such as a card number, security code, expiration date, cardholder name, a personal identification number (PIN), or other card information that can be collected by the point-of-sale device 109. In other instances, the request can include a cryptogram representing the card details and/or transaction details can be encrypted in some implementations.

At block 304, the payment authorization service 111 can identify a user account associated with the card identified in the request to authorize received from the point-of-sale device 109. The user account can be identified based upon the details of the card that was presented to the point-of-sale device 109.

At block 305, the payment authorization service 111 can perform primary authentication of the card presented to the point-of-sale device 109. Primary authentication can take the form of validating a chip or a chip and PIN provided to the point-of-sale device 109. Primary authentication can also comprise validating that a transaction complies with spending or credit limits associated with a user account and performing fraud detection procedures that a card issuer can have in place.

At block 307, the payment authorization service 111 can identify one or more secondary devices 105 associated with the card. The secondary devices 105 can be associated with a user account according to the process outlined in FIG. 2. As noted in the discussion of FIG. 2, a user can associate one or more secondary devices 105 of varying types with the user account. A secondary device 105 can be identified by determining whether one or more secondary devices 105 are associated with the user account in user device data 135 in the data store 112.

At block 310, the payment authorization service 111 can identify one or more passive secondary authentication rules 227 that are associated with user account data 131 linked to the card transaction request. The payment authorization service 111 can also determine whether there are any passive authentication rules 227 that are triggered by the transaction details that, such as an amount of the transaction, a type of goods or services, or a location of the transaction.

The passive authentication rules 227 can be specified by a user and associated with the user account or specified by a card issuer. A passive authentication rule 139 can specify presence of a secondary device 105 in order to approve the transaction. A passive authentication rule 139 can also specify other factors, such as biometric measurements, velocity, or location. For example, the passive authentication rule 139 can specify that for some or all transactions, that a user's heart rate or blood pressure as detected by a secondary device 105 having biometric measuring capabilities should be within a normal or specified range. A passive authentication rule 139 can also specify that the velocity of the user as detected by a secondary device 105 should be less than a maximum velocity. A passive authentication rule 139 can also specify that some or all transactions require verification of the user's location, either by presence of a secondary device 105 in proximity to the point-of-sale device 109, or within a specified geofence selected by the user.

A passive authentication rule 139 can also specify multiple checks that should be performed in association with potentially multiple secondary devices 105 for the payment authorization service 111 to approve a transaction. For example, the passive authentication rule 139 can specify that presence of multiple secondary devices 105 should be confirmed by the client application 151 before allowing the payment authorization service 111 to approve a transaction. The user can also specify that presence of secondary devices 105 and biometric data should be checked by the client application 151 or the payment authorization service 111 before approving a transaction.

At block 313, the payment authorization service 111, upon identifying passive secondary authentication rules 227 that are applicable to the user account and to the transaction based upon the transaction details, can perform the passive secondary authentication process specified by the one or more passive authentication rule 139 identified at block 310.

As noted above, a passive authentication rule 139 represents secondary authentication measure that can be utilized to determine whether to approve or deny a card payment request received from a point-of-sale device 109. A passive authentication rule 139 can require presence of one or more secondary devices 105, such as a phone, wearable, or tracker, in a location associated with the point-of-sale device 109 before approval of a card payment request is provided by the payment authorization service 111 to the point-of-sale device 109. A passive authentication rule 139 can require that a user explicitly approve or deny a payment using one or more secondary devices 105 before approval of a card payment request is provided by the payment authorization service 111 to the point-of-sale device 109. A passive authentication rule 139 can require a biometric factor be captured by one or more secondary devices 105 and be provided to the payment authorization service 111 before approval of a card payment request is provided by the payment authorization service 111 to the point-of-sale device 109. As another example, a passive authentication rule 139 can require that a biometric factor, such as heart rate, blood pressure, or a stress-related biometric data point, be captured by a wearable device or another device of the user, report a biometric factor that is within an acceptable range before approval of a card payment request is provided by the payment authorization service 111 to the point-of-sale device 109.

Accordingly, the payment authorization service 111 can transmit a request to a client device 102 associated with a user account to provide information about presence of secondary devices 105 in proximity to the location of the point-of-sale device 109 or to provide biometric data specified by a respective passive authentication rule 139.

At step 316, the payment authorization service 111 determines whether the passive secondary authentication has been successful. Passive secondary authentication is deemed successful if the passive authentication rules 227 can be satisfied. If the passive secondary authentication is deemed successful, the process proceeds to step 321, where the payment authorization service 111 authorizes the transaction by transmitting an indication of approval to the payment authorization service 111, or a transaction authorization indication. The transaction authorization indication can be routed through a payment network as well as other systems before arriving at the point-of-sale device 109.

If the passive secondary authentication is unsuccessful, the process can proceed from step 316 to 319, wherein the payment authorization service 111 denies the transaction. Passive secondary authentication is deemed unsuccessful if at least one of the passive authentication rules 227 cannot be satisfied. If the passive secondary authentication is deemed unsuccessful, the payment authorization service 111 denies the transaction by transmitting an indication of denial to the payment authorization service 111. The denial indication can be routed through a payment network as well as other systems before arriving at the point-of-sale device 109. Thereafter, the process can proceed to completion.

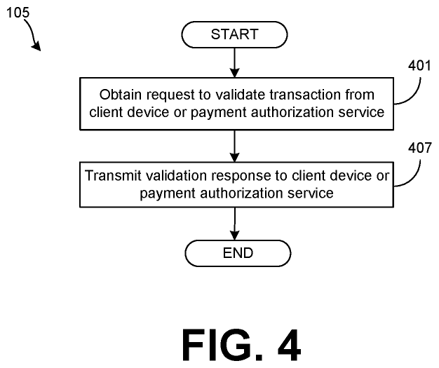

FIG. 4 illustrates a flowchart that provides an example of the operation of the components of the network environment 100. It is understood that the flowchart of FIG. 4 provides merely an example of the many different types of functional arrangements that can be employed to implement the operation of the depicted portion of the network environment 100. As an alternative, the flowchart of FIG. 4 can be viewed as depicting an example of elements of a method implemented within the network environment 100. In particular, the flowchart of FIG. 4 depicts the how a secondary device 105 can perform passive secondary authentication for a card transaction.

In one example, the payment authorization service 111 can receive a request to authorize a card transaction. The request can be received from or on behalf of a point-of-sale device 109 to which a user has presented a payment or transaction card (e.g., a debit, credit, or charge card) or a client device 102 running a mobile wallet application 150 with which a payment account (e.g., a credit, debit, or charge card account; a bank account; etc.) of the user is linked. In some cases, the request to authorize a card transaction can be received from an online payment gateway if the user is attempting an online payment transaction.

After performing primary authentication of the card presented for the transaction, the payment authorization service 111 can identify one or more secondary devices 105 associated with the card. As noted above, a user can associate one or more secondary devices 105 of varying types with the user account. A secondary device 105 can be identified by determining whether one or more secondary devices 105 are associated with the user account in user device data 135 in the data store 112.

Accordingly, at block 401, the secondary device 105 identified by the payment authorization service 111 can receive a request to validate a transaction. The request can be received from a client application 151 or from the payment authorization service 111 directly in the case of a secondary device 105 that has the capability to communicate directly with the network 115. The request can comprise a request to confirm presence of the secondary device 105 in proximity to a client device 102 or to provide a network location or geolocation of the secondary device 105 so that the payment authorization service 111 can validate the presence or location of the secondary device 105. The request can also comprise a user account identifier associated with the request, which can be validated by an application running on the secondary device 105.

At block 407, the secondary device 105 can transmit a validation response to the payment authorization service 111 or the client application 151. The response can confirm presence of the secondary device 105 in proximity to the client device 102 or provide the location of the secondary device 105, which can be validated by the payment authorization service 111. In the case of a validation response that is sent to the client application 151, the client application 151 can forward the validation response to the payment authorization service 111.

Thereafter, the process proceeds to completion.

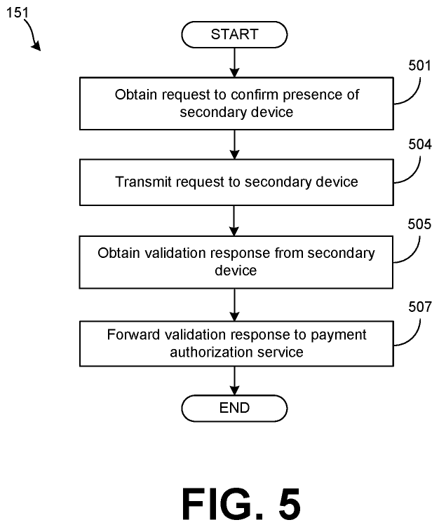

FIG. 5 illustrates a flowchart that provides an example of the operation of the components of the network environment 100. It is understood that the flowchart of FIG. 5 provides merely an example of the many different types of functional arrangements that can be employed to implement the operation of the depicted portion of the network environment 100. As an alternative, the flowchart of FIG. 5 can be viewed as depicting an example of elements of a method implemented within the network environment 100. In particular, the flowchart of FIG. 5 depicts the how the client application 151 can be utilized to facilitate secondary authentication of transactions on behalf of the payment authorization service 111.

In one example, the payment authorization service 111 can receive a request to authorize a card transaction. The request can be received from or on behalf of a point-of-sale device 109 to which a user has presented a payment or transaction card (e.g., a debit, credit, or charge card) or a client device 102 running a mobile wallet application 150 with which a payment account (e.g., a credit, debit, or charge card account; a bank account; etc.) of the user is linked. In some cases, the request to authorize a card transaction can be received from an online payment gateway if the user is attempting an online payment transaction.

After performing primary authentication of the card presented for the transaction, the payment authorization service 111 can identify one or more secondary devices 105 associated with the card. As noted above, a user can associate one or more secondary devices 105 of varying types with the user account. A secondary device 105 can be identified by determining whether one or more secondary devices 105 are associated with the user account in user device data 135 in the data store 112.

In many instances, a secondary device 105 might not possess the capability to communicate directly with the network 115. Accordingly, secondary authentication can be performed by confirming presence of the secondary device 105 in proximity to a client device 102 that acts as a primary device. Accordingly, the payment authorization service 111 can transmit a request to the client application 151 running on a client device 102 to confirm presence of the secondary device 105.

Therefore, at block 501, the client application 151 can obtain a request to confirm presence of the secondary device 105. The request can comprise an identifier of the device that is stored in the data store 112 in association with a user account corresponding to the card that is being used in the transaction.

At step 504, the client application 151 can transmit a request to the secondary device 105 to confirm its presence in proximity to the client device 102. In some instances, the secondary device 105 might be paired with the client device 102 via a Bluetooth or ultra-wide band connection. Accordingly, the client application 151 can ping the secondary device 105 or confirm with the operating system of the client device 102 that the secondary device 105 is in communication with or proximity to the client device 102.

The request can comprise a request to confirm presence of the secondary device 105 in proximity to a client device 102 or to provide a network location or geolocation of the secondary device 105 so that the payment authorization service 111 can validate the presence or location of the secondary device 105. The request can also comprise a user account identifier associated with the request, which can be validated by an application running on the secondary device 105.

At block 505, the client application 151 can obtain a validation response from the secondary device 105. The response can confirm presence of the secondary device 105 in proximity to the client device 102 or provide the location of the secondary device 105.

At block 507, the client application 151 can forward the validation response received from the secondary device 105 to the payment authorization service 111. In a scenario where the client application 151 does not receive a response from the secondary device 105, the client application 151 can forward an indication that the secondary device 105 is not in proximity to or in the presence of the client device 102, in which case the payment authorization service 111 can determine that secondary authentication fails. Thereafter, the process can proceed to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103,106.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a request to authorize a card payment from a point-of-sale device, wherein the request is associated with an attempted card payment;
determine a user account associated with the request to authorize the card payment;
identify at least one passive authentication factor linked to the user account, the at least one passive authentication factor associated with at least one device associated with the user account;
determine whether the at least one passive authentication factor is satisfied based upon an analysis of the at least one device; and
in response to determining that the at least one passive authentication factor is satisfied, transmit a transaction authorization indication to the point-of-sale device.

2. The system of claim 1, wherein the at least one device associated with the user account comprises a mobile device, wearable device, or a tracking device.

3. The system of claim 2, wherein the machine-readable instructions determine whether the at least one passive authentication factor is satisfied based upon an analysis of the at least one device by causing the computing device to at least:
transmit a request to a mobile application with which the user account is associated to detect presence of the at least one device within proximity of a user mobile device, wherein the mobile application detects presence using a Bluetooth or near-field communication (NFC) interface of the user mobile device.

4. The system of claim 2, wherein the machine-readable instructions determine whether the at least one passive authentication factor is satisfied based upon an analysis of the at least one device by causing the computing device to at least:
obtain biometric data from the at least one device; and
determine that the biometric data is within an acceptable range.

5. The system of claim 1, wherein the machine-readable instructions cause the computing device to identify at least one passive authentication factor linked to the user account when at least one aspect of the card payment requires at least a secondary authentication.

6. The system of claim 5, wherein the at least one aspect of the card payment comprises a payment amount, a geographic location associated with the at least one device, or a type of goods or services associated with the card payment.

7. The system of claim 1, wherein the machine-readable instructions cause the computing device to determine whether the at least one passive authentication factor is satisfied without a user interaction.

8. A method, comprising:
receiving a request to authorize a card payment from a point-of-sale device, wherein the request is associated with an attempted card payment;
determining a user account associated with the request to authorize the card payment;
identifying at least one passive authentication factor linked to the user account, the at least one passive authentication factor associated with at least one device associated with the user account;
determining whether the at least one passive authentication factor is satisfied based upon an analysis of the at least one device; and
in response to determining that the at least one passive authentication factor is satisfied, transmitting a transaction authorization indication to the point-of-sale device.

9. The method of claim 8, wherein the at least one device associated with the user account comprises a mobile device, wearable device, or a tracking device.

10. The method of claim 9, wherein determining whether the at least one passive authentication factor is satisfied based upon an analysis of the at least one device further comprises:
transmitting a request to a mobile application with which the user account is associated to detect presence of the at least one device within proximity of a user mobile device, wherein the mobile application detects presence using a Bluetooth or near-field communication (NFC) interface of the user mobile device.

11. The method of claim 9, wherein determining whether the at least one passive authentication factor is satisfied based upon an analysis of the at least one device further comprises:
obtaining biometric data from the at least one device; and
determining that the biometric data is within an acceptable range.

12. The method of claim 8, wherein identifying at least one passive authentication factor linked to the user account is performed when at least one aspect of the card payment requires at least a secondary authentication.

13. The method of claim 12, wherein the at least one aspect of the card payment comprises a payment amount, a geographic location associated with the at least one device, or a type of goods or services associated with the card payment.

14. The method of claim 8, further comprising determining whether the at least one passive authentication factor is satisfied without a user interaction.

15. A non-transitory, computer-readable medium, comprising machine-readable instructions that, when executed by a processor of a computing device, cause the computing device to at least:
receive a request to authorize a card payment from a point-of-sale device, wherein the request is associated with an attempted card payment;
determine a user account associated with the request to authorize the card payment;
identify at least one passive authentication factor linked to the user account, the at least one passive authentication factor associated with at least one device associated with the user account;
determine whether the at least one passive authentication factor is satisfied based upon an analysis of the at least one device; and
in response to determining that the at least one passive authentication factor is satisfied, transmit a transaction authorization indication to the point-of-sale device.

16. The non-transitory, computer-readable medium of claim 15, wherein the at least one device associated with the user account comprises a mobile device, wearable device, or a tracking device.

17. The non-transitory, computer-readable medium of claim 16, wherein the machine-readable instructions determine whether the at least one passive authentication factor is satisfied based upon an analysis of the at least one device by causing the computing device to at least:
transmit a request to a mobile application with which the user account is associated to detect presence of the at least one device within proximity of a user mobile device, wherein the mobile application detects presence using a Bluetooth or near-field communication (NFC) interface of the user mobile device.

18. The non-transitory, computer-readable medium of claim 16, wherein the machine-readable instructions determine whether the at least one passive authentication factor is satisfied based upon an analysis of the at least one device by causing the computing device to at least:
obtain biometric data from the at least one device; and
determine that the biometric data is within an acceptable range.

19. The non-transitory, computer-readable medium of claim 15, wherein the machine-readable instructions cause the computing device to identify at least one passive authentication factor linked to the user account when at least one aspect of the card payment requires at least a secondary authentication.

20. The non-transitory, computer-readable medium of claim 15, wherein the machine-readable instructions cause the computing device to determine whether the at least one passive authentication factor is satisfied without a user interaction.
